(19) United States
(12) Patent Application Publication
(10) Pub. No.: US 2013/0109556 A1
(43) Pub. Date: May 2, 2013

(54) Method of Manufacturing a Display Unit

(71) Applicant: The Procter & Gamble Company, Cincinnati, OH (US)

(72) Inventors: Achim Simon Fischer, Jiangsu Province (CN); Annick Antoine Sonia Van Put, Strombeek-Bever (BE)

(73) Assignee: THE PROCTER & GAMBLE COMPANY, Cincinnati, OH (US)

(21) Appl. No.: 13/659,982

(22) Filed: Oct. 25, 2012

(30) Foreign Application Priority Data
Oct. 27, 2011 (EP) 11186864.2

(51) Int. Cl. B41F 13/56

(52) U.S. Cl. 493/324

(57) ABSTRACT

A method of manufacturing a temporary display unit. The method comprises acquiring a blank sheet of display unit material, cutting the sheet to make a sheet having a cut component in a first location, applying indicia to the cut component and assembling a temporary display unit comprising the cut component.

### TECHNICAL FIELD

The present invention relates to the field of temporary, point of sale, display units and methods of producing, assembling and decorating such units.

### BACKGROUND TO THE INVENTION

As shelf space becomes less available and each shelf more crowded, the vendor must seek new and innovative ways in which to promote a given product. Point of sale display units are therefore becoming increasingly popular for the promotion of goods. Point of sale display units are temporary shelving units which can be assembled and disassembled with ease and placed at any given, convenient location. Such units are generally made from disposable materials such as cardboards or other light weight material, and are described in the prior art. GB876893 describes a display unit made by hingedly attaching single piece blanks of foldable material, arranged such that when the sheet is folded to form the display unit the side panels extend back from the front panel and are lockable in place. U.S. Pat. No. 3,863,575 describes a display stand having a completely finished outer surface and consisting of a plurality of components prepared from separate blanks that are folded, arranged and secured. U.S. Pat. No. 3,766,675 describes a modular advertising display comprising at least 2 display modules and at least 2 connectors.

Generally these temporary shelving units are assembled from sheets of material which are precut to cooperate with one another in a predesigned mechanism of assembly. The shelving unit may be used as is or as a display surface to which further decorative panels or printed material can be attached. More recently, as is described in GB2436885, the display unit is printed with advertising material, prior to being cut. The printed and subsequently cut sheets are then shipped to the retailer or service provider, who then builds the display unit. However the Applicant has discovered a number of problems with this process. Cutting of the sheets is generally done at a central location, since cutting equipment is expensive. However, to make the production of the display cost effective, the manufacturer is required to cut a large number of sheets. Thus potential for unused or incorrectly located inventory is high. The printed and cut pieces can become separated during transport, such that on arrival at the retailer, the retailer does not have all necessary parts to build the display unit or complete the decoration of a display unit.

The Applicants have found that a sheet can be precut, packaged and then printed centrally or at a location closer to the point of use and in this way counteract the problems set out above. Sheets of material for use in assembly or decoration of a display unit can be produced and cut in large quantities and then have indicia applied thereon on demand.

### SUMMARY OF THE INVENTION

According to the present invention there is provided a method of manufacturing a temporary display unit by sequentially following the steps of:

a) Acquiring a blank sheet of display unit material;

b) Cutting said blank to make a sheet comprising at least one cut component in a first location;

c) Optionally packaging said sheet of cut component(s);

d) Optionally delivering said sheet of cut component(s) to a second location;

e) Applying indicia to said sheet of cut component; and

f) Assembling a temporary display unit that includes said sheet of cut component.

### DETAILED DESCRIPTION OF THE INVENTION

The present relates to a method of manufacturing a temporary display unit, and more specifically, a component of a temporary display unit. A temporary display unit comprises components which are designed to cooperate. Such components may be building components, designed to build a display unit when assembled, or decoration components, which are designed to decorate the display unit. The decoration component may be designed to cooperate with a building component or another decoration component. The present invention relates to a method of manufacturing a building or decoration component of a display unit.

The building components will preferably be selected from the group consisting of a display unit back, display unit foot, display unit left side, display unit right side, display unit shelf, display unit top and mixtures thereof. The decoration components will preferably be selected from the group consisting of decoration back, decoration left external side, decoration left internal side, decoration right external side, decoration right internal side, decoration top shelf, decoration bottom shelf, decoration foot, decoration front of shelf and mixtures thereof.

### Materials for the Display Unit Material

The display unit component may be made from any suitable material. The choice of material will depend on the products that are to be displayed on the unit and whether the component is a building or decoration component. Hence, for example, the choice of material of a building component may range from a light cardboard, suitable for displaying printed indicia only, to a more robust material, capable of displaying products of varying weights. A decoration component may preferably be made from a lighter material. Preferably the blank sheet of material is selected from the group consisting of cardboard, wood, fiberboard, plastic, metal, other foldable sheet material or mixtures thereof. Preferably the material is cardboard, more preferably corrugated cardboard. Since the unit is for temporary use only, it is preferable that the material is also recyclable.

### Cutting the Blank Sheet

The blank sheet of material is cut to produce a component, and remnant sheet material. Preferably the sheet is cut into a plurality of components to reduce the amount of remnant material. The sheet may be cut using any known equipment. Preferred equipment includes laser cutting or cutting plotter equipment. However, preferably the sheet is cut using standard, and commonly available, die cutting equipment.

The sheet may be cut to produce building components or decoration components or mixtures thereof. Building components will preferably be selected from the group consisting of a display unit back, display unit foot, display unit left side, display unit right side, display unit shelf, display unit top and mixtures thereof. Alternatively the building component making up the back and side walls of the display unit may be a single cut component, which is subsequently folded to produce at least a back and two side walls. Decoration components will preferably be selected from the group consisting of decoration back, decoration outer left side, decoration inner left side, decoration outer right side, decoration inner right side, decoration top shelf, decoration bottom shelf, decoration foot, decoration front of shelf and mixtures thereof.

The components may be connected together using any suitable, known method. The components are preferably cut with protruding tabs and slots that cooperate together to link and lock the building components together to build the display unit or attach the decoration components to each other or to the building components. In this embodiment one component is cut with a protruding tab and the neighboring component is cut with a cooperating slot, into which the tab is pushed. The tabs and slots are cut such that the fit is tight enough to hold the pieces together, preferably using friction.

Alternatively the components can be cut with protruding tabs, which can be attached to one another in order to link and lock the pieces together. The display unit can be constructed according to known methods. See for example the method described in GB876893. Particularly preferred are the methods described in GB2436885.

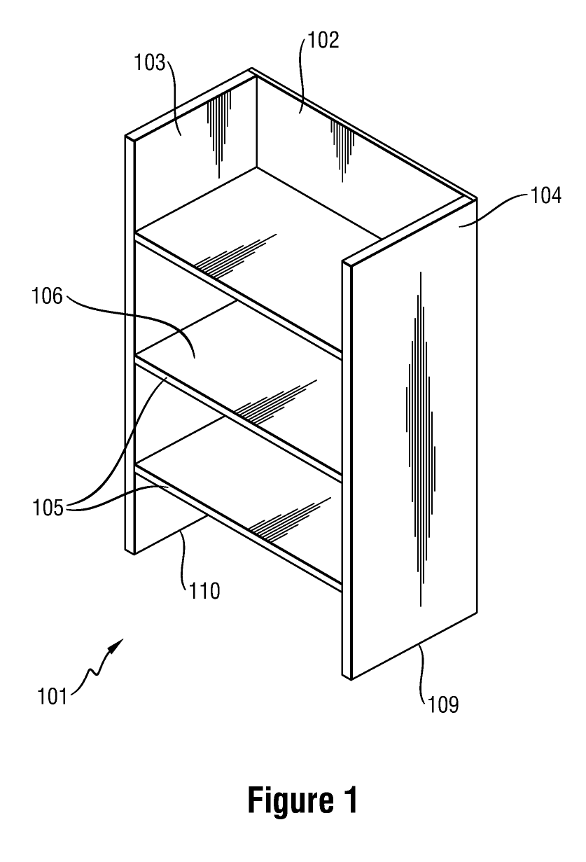

FIG. 1

A preferred display unit (101) is shown in FIG. 1. The display unit (101) comprises a back wall (102), side walls (103, 104) and a plurality of shelves (105) supported between the back and side walls (102, 103, and 104). Each of the shelves (105) presents an upper surface (106) upon which articles may be displayed. The bottom edges (108,109, 110) of the back and side walls are preferably substantially straight. The unit is preferably symmetrical about an axis that extends centrally through the back wall, perpendicular to the bottom edge (108). Symmetry is preferred in order to provide maximum stability and aesthetic appeal of the unit. The side wall preferably comprises a plurality of slots along the length of the side wall, from the bottom edge (109, 110). The slots are preferably of size and shape to cooperate with tabs provided on the shelf pieces. The slots may penetrate the width of the side wall or alternatively the slot may not penetrate through to the outer surface of the side wall. In this latter embodiment the smooth fluid surface of the outer side wall is not compromised by a hole caused by the slot. The side walls are preferably provided with pairs of slots, which are then mirrored at the same height and spacing on the other side wall, such that the shelf is secure and parallel. It is preferred that the side walls are provided with a plurality of pairs of slots along the length of the side wall, such that the user has maximum flexibility of shelf height. In a further alternative embodiment, the back wall may equally be provided with a slot or multiple slots.

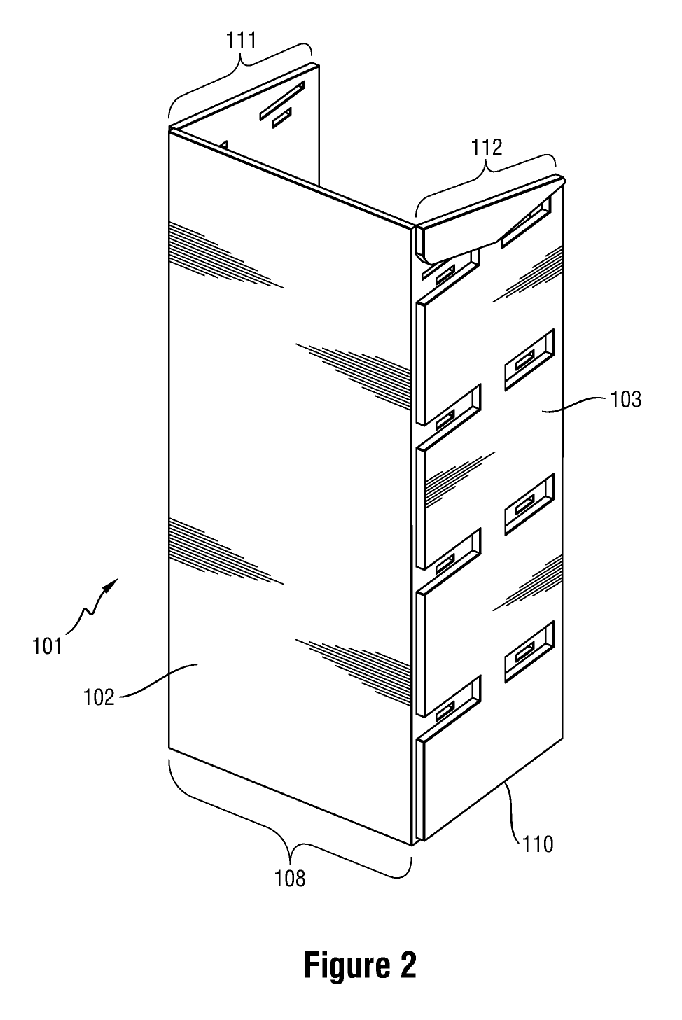

FIG. 2

Shows the preferred display unit of FIG. 1 from the back.

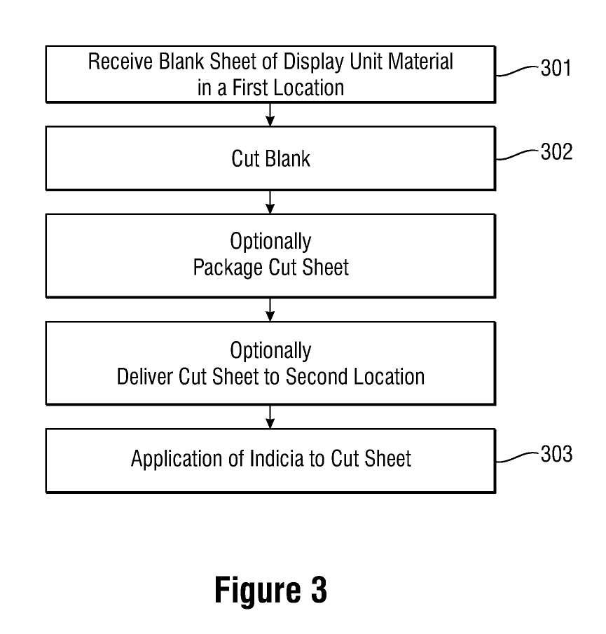

FIG. 3

Steps performed in the manufacture of shelving unit (101) are illustrated in FIG. 3. At step (301) a sheet of material is received and a step (302) the sheet is cut to produce pieces. Typically a die cutting process is performed, although other techniques can also be suitable, depending on the material used. At step (303) an indicia is applied to the cut sheet of components, preferably using a printing process. Following the steps of the present invention, the display unit can then be constructed and decorated.

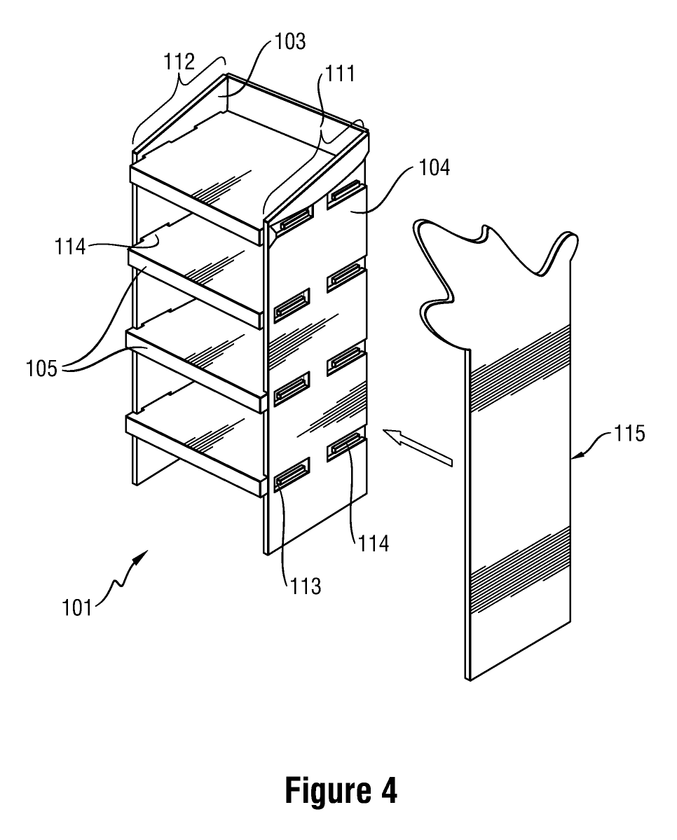

FIG. 4

Shows an assembled display unit, exhibiting slots (113) provided in the side walls (103,104) and tabs (114) of the shelf visible in the slot (113). Also visible is a decoration right external side component (115) to be attached to the right side wall (104) and which will hide the slots and tabs.

Preferably, cut components are maintained within the sheet after cutting. The benefit in not removing the cut components from the remainder of the sheet is that the pieces can be kept together and flat, especially during transportation. More preferably several sheets of cut components are stacked one on top of the other. A further preferred embodiment is that the cut sheet or preferably stacked cut sheets are packaged together. The cut sheets of material may then be transported to a second location, which may be different from the first location where cutting took place. In this embodiment, the sheets can be decorated with the required indicia as needed, depending on the products to be displayed or the indicia to be displayed. It is clear, however that the removal of the sheet to a second location is not essential to the present method.

### Application of the Indicia

The application of the indicia may take place immediately after cutting, in the same location, but preferably in a second location. Indicia can be applied to the component by any suitable method. For example, pre-prepared indicia can be adhered onto the component using adhesive, including self-adhesive. However, preferably the components are printed with indicia. More preferably the cut components are maintained within the sheet during application of the indicia. More preferably the sheet of cut components are printed. Any suitable method of printing may be used. More preferably the indicia are printed using ink jet printing, flexographic printing, laser printing, gravure printing, pad printing and mixtures thereof. More preferably the indicia are printed using ink jet, laser and flexographic printing.

By the term ‘indicia’ it is understood to mean any visual illustration. A visual illustration may include: colour; text; graphic images; symbols; drawings; diagrams; brand identifying colour, text, symbols; informative or decorative illustrations; photographs; and combinations thereof. More preferably the indicia of the present invention are selected from colours, text, preferably advertising copy and brand names, symbols, brand identifiers, advertising copy and combinations thereof.

Once all components of the display unit have been cut and decorated, where appropriate, the display unit can be built and decoration components added.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of manufacturing a temporary display unit by sequentially following the steps of :
a) Acquiring a blank sheet of display unit material;
b) Cutting said blank to make a sheet comprising at least one cut component in a first location;
c) Optionally packaging said sheet of cut component;
d) Optionally delivering said sheet of cut component to a second location;
e) Applying indicia to said sheet of cut component; and
f) Assembling a temporary display unit that includes said sheet of cut component.

2. The method according to claim 1 wherein at least one cut component is selected from the group consisting of a building component, a decoration component and mixtures thereof.

3. The method according to claim 1 wherein the sheet is cut into a plurality of cut components.

4. The method according to claim 1 wherein the cut component cooperates with at least one other cut component.

5. The method according to claim 1 wherein the sheet of cut component(s) are packaged together.

6. The method according to claim 1 wherein the sheet of cut component(s) is delivered to a second location.

7. A method according to claim 1, wherein said sheet of display unit material is selected from the group consisting of cardboard, plastic, metal or mixtures thereof, preferably cardboard, more preferably corrugated cardboard.

8. A method according to claim 1 wherein said blank is cut into a component selected from display unit back, display unit foot, display unit left side, display unit right side, display unit shelf, display unit top, decoration back, decoration left external side, decoration left internal side, decoration right external side, decoration right internal side, decoration top shelf, decoration bottom shelf, decoration foot, decoration front of shelf and mixtures thereof.

9. A method according to claim 1 wherein the cut component(s) are maintained within the sheet during transportation.

10. A method according to claim 1 wherein a plurality of sheets of cut component(s) are packaged together.

11. A method according to claim 1 wherein indicia are applied to the sheet by printing, preferably ink jet printing.
